(19) United States
(12) Patent Application Publication
(10) Pub. No.: US 2021/0286964 A1
(43) Pub. Date: Sep. 16, 2021

(54) TOUCH DISPLAY DEVICE INTEGRATED WITH FINGERPRINT RECOGNITION AND MANUFACTURING METHOD THEREOF

(71) Applicant: Shenzhen China Star Optoelectronics Semiconductor Display Technology Co., Ltd., Shenzhen (CN)

(72) Inventor: Wei LU, Shenzhen (CN)

(73) Assignee: Shenzhen China Star Optoelectronics Semiconductor Display Technology Co., Ltd., Shenzhen (CN)

(21) Appl. No.: 16/624,346

(22) PCT Filed: Nov. 6, 2019
(86) PCT No.: PCT/CN2019/116105

§ 371 Date: Dec. 19, 2019

(30) Foreign Application Priority Data
Aug. 19, 2019 (CN) 201910765395.7

(51) Int. Cl. G06K 9/00; G06F 3/041; G06F 3/042

(52) U.S. Cl. CPC G06K 9/0004; G06F 3/04164; G06F 2203/04103; G06F 3/0421; G06F 3/0412; G06F 3/0418

(57) ABSTRACT

A touch display device includes a display screen and a touch chip. The display screen includes pixel units arranged in an array, each pixel unit including a gate line and a touch signal line intersecting with each other, a touch sensing unit, and a touch transistor. The touch sensing unit includes a touch sensing electrode. A gate electrode and a drain electrode of the touch transistor are connected to the gate line and the touch sensing unit respectively. The touch chip is connected to a source electrode of the touch transistor through the touch signal line. The touch chip charges the touch sensing unit while the display screen displays the n-th frame of picture, discharges the touch sensing unit while the display screen displays the (n+1)-th frame of picture, and compares charge data of the touch sensing unit to determine coordinates of touch positions and to generate corresponding fingerprint signals.

### BACKGROUND OF DISCLOSURE

### 1. Field of Disclosure

The present disclosure relates to the field of display technology, and more particularly, to a touch display device integrated with fingerprint recognition.

### 2. Description of Related Art

In recent years, there has been an increasing interest in display devices with in-display fingerprint recognition. However, conventional touch display panels always have some problems such as large signal noise, low touch accuracy, low product yield, etc., leading to a bad user experience.

Furthermore, for conventional display devices with fingerprint recognition, their fingerprint recognition modules are independent systems without being fully integrated with touch display panels. Also, since the fingerprint recognition modules only recognize users' identities when the display devices are unlocked, they cannot execute a real-time monitoring. In view of the above factors, conventional touch display devices not only have high costs but also have a lack of safety and convenience of use.

### SUMMARY

A technical problem is that, for conventional display devices with fingerprint recognition, their fingerprint recognition modules are independent systems without being fully integrated with touch display panels.

The object of the present disclosure is to provide a touch display device integrated with fingerprint recognition to reduce signal noise and to simultaneously improve safety and convenience of use.

In order to realize the above object, the present disclosure provides a touch display device, including: a display screen including a plurality of pixel units arranged in an array, each of the plurality of pixel units including: a gate line and a touch signal line which intersect with each other; a touch sensing unit including a touch sensing electrode; and a touch transistor, wherein a gate electrode of the touch transistor is electrically connected to the gate line, and a drain electrode of the touch transistor is electrically connected to the touch sensing unit; and a touch chip electrically connected to a source electrode of the touch transistor through the touch signal line and configured to, for the each of the plurality of pixel units: charge the touch sensing unit while the display screen displays the n-th frame of picture, and discharge the touch sensing unit while the display screen displays the (n+1)-th frame of picture, wherein n is a natural number; and compare charge data of the touch sensing unit to determine a coordinate of a touch position and to generate a corresponding fingerprint signal.

In some embodiments, the touch display device further includes a fingerprint recognizing module electrically connected to the touch chip and configured to recognize a fingerprint signal according to preset fingerprint data.

In some embodiments, the drain electrode of the touch transistor is electrically connected to the touch sensing electrode.

In some embodiments, each of the plurality of pixel units further includes: a plurality of data lines intersecting with the gate line; a plurality of sub-pixel units, wherein each of the plurality of sub-pixel units includes an anode, an organic light-emitting layer, and a cathode which sequentially overlap with each other; and a plurality of pixel transistors, wherein drain electrodes of the plurality of pixel transistors are electrically connected to the plurality of sub-pixel units respectively.

In some embodiments, the touch display device further includes: a source-electrode driving chip electrically connected to source electrodes of the plurality of pixel transistors through the plurality of data lines and configured to drive the display screen to display pictures; and a gate-electrode driving chip electrically connected to gate electrodes of the plurality of pixel transistors and to the gate electrode of the touch transistor through the gate line, and configured to turn on the plurality of pixel transistors and the touch transistor line by line.

In some embodiments, the touch chip charges the touch sensing unit line by line while the display screen displays the n-th frame of picture, and the touch chip discharges the touch sensing unit line by line while the display screen displays the (n+1)-th frame of picture.

In order to realize the above object, the present disclosure further provides a method of manufacturing a touch display device, including: providing a thin-film transistor substrate, and defining a light-emitting region and a touch region on the thin-film transistor substrate; forming a light-emitting device layer in the light-emitting region and on the thin-film transistor substrate, and forming at least one touch sensing electrode in the touch region and on the thin-film transistor substrate; forming an encapsulation layer covering the light-emitting device layer and the at least one touch sensing electrode; and electrically connecting a source-electrode driving chip with the light-emitting device layer by a bonding process, and electrically connecting a touch chip with the at least one touch sensing electrode by the bonding process.

In some embodiments, the providing the thin-film transistor substrate includes forming a thin-film transistor layer on an underlay substrate, wherein the underlay substrate is one of a silicon substrate and a glass substrate.

In some embodiments, the forming the light-emitting device layer in the light-emitting region and on the thin-film transistor substrate includes: forming a plurality of anodes in the light-emitting region and on the thin-film transistor substrate; and by using a mask to cover the touch region, and forming an organic light-emitting layer and a cathode in sequence on each of the plurality of anodes.

In some embodiments, the light-emitting device layer includes a plurality of sub-pixel units, and each of the plurality of sub-pixel units includes an anode, an organic light-emitting layer, and a cathode which sequentially overlap with each other.

In order to realize the above object, the present disclosure further provides a touch display device, including: a display screen including a plurality of pixel units arranged in an array, each of the plurality of pixel units including: a gate line and a touch signal line which intersect with each other; a touch sensing unit including a touch sensing electrode; and a touch transistor, wherein a gate electrode of the touch transistor is electrically connected to the gate line, and a drain electrode of the touch transistor is electrically connected to the touch sensing unit; and a touch chip electrically connected to a source electrode of the touch transistor through the touch signal line and configured to, for the each of the plurality of pixel units: charge the touch sensing unit while the display screen displays the n-th frame of picture line by line, and discharge the touch sensing unit while the display screen displays the (n+1)-th frame of picture line by line, wherein n is a natural number; and compare charge data of the touch sensing unit to determine a coordinate of a touch position and to generate a corresponding fingerprint signal.

In some embodiments, the touch display device further includes a fingerprint recognizing module electrically connected to the touch chip and configured to recognize a fingerprint signal according to preset fingerprint data.

In some embodiments, each of the plurality of pixel units further includes: a plurality of data lines intersecting with the gate line; a plurality of sub-pixel units, wherein each of the plurality of sub-pixel units includes an anode, an organic light-emitting layer, and a cathode which sequentially overlap with each other; and a plurality of pixel transistors, wherein drain electrodes of the plurality of pixel transistors are electrically connected to the plurality of sub-pixel units respectively.

In some embodiments, the touch display device further includes: a source-electrode driving chip electrically connected to source electrodes of the plurality of pixel transistors through the plurality of data lines and configured to drive the display screen to display pictures; and a gate-electrode driving chip electrically connected to gate electrodes of the plurality of pixel transistors and to the gate electrode of the touch transistor through the gate line, and configured to turn on the plurality of pixel transistors and the touch transistor line by line.

The beneficial effect of the present disclosure is that, a touch display device integrated with fingerprint recognition is provided, which can reduce signal noise and also improve safety and convenience of use.

### BRIEF DESCRIPTION OF DRAWINGS

To ensure the features and the technical content of the disclosure are more apparent and easier to understand, please refer to the explanation and the accompanying drawings of the disclosure as follows. However, the accompanying drawings are merely for reference without limiting the disclosure.

FIGS. 1A-1D are partially cross-sectional views of implementing a method of manufacturing a touch display device according to the present disclosure.

FIG. 2 is a schematic diagram of a circuit structure of the touch display device as shown in FIG. 1D.

### DETAILED DESCRIPTION OF EMBODIMENTS

To ensure the objects, the technical solutions, and the effects of the disclosure are clearer and more specific, the disclosure will be explained in conjunction with the accompanying drawings in detail further below. It should be understood that the embodiments described herein are merely a part of the embodiments of the present disclosure instead of all of the embodiments and not used to limit the disclosure.

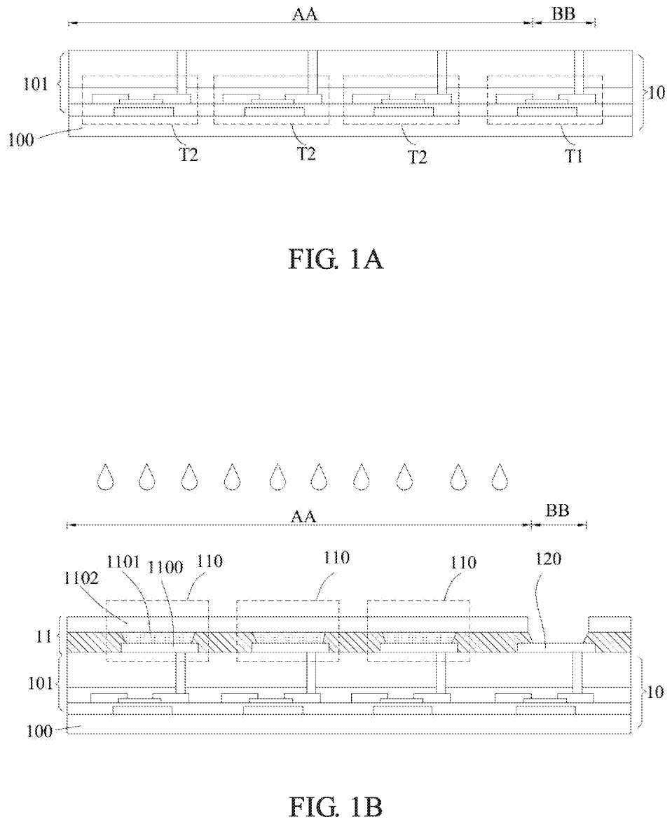

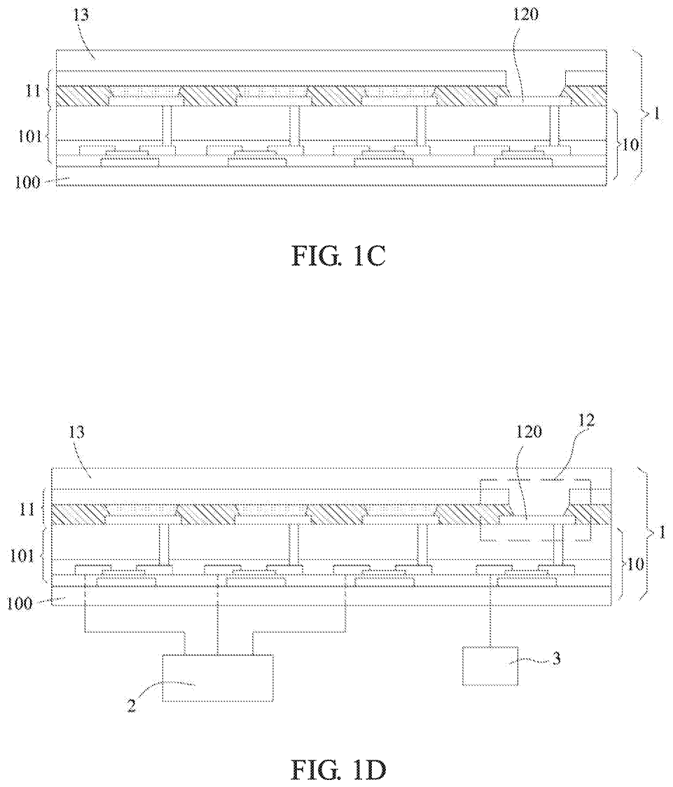

Please refer to FIGS. 1A-1D, which are partially cross-sectional views of implementing a method of manufacturing a touch display device according to the present disclosure. In the present disclosure, the method of manufacturing the touch display device includes the following steps:

Firstly, as shown in FIG. 1A, a thin-film transistor substrate 10 is provided, and a light-emitting region AA and a touch region BB are defined on the thin-film transistor substrate 10. Specifically, a thin-film transistor layer 101 is formed on an underlay substrate 100. The underlay substrate 100 can be one of a silicon substrate and a glass substrate. In the present embodiment, the thin-film transistor layer 101 includes at least one touch transistor T1 and a plurality of pixel transistors T2.

Next, as shown in FIG. 1B, a light-emitting device layer 11 is formed in the light-emitting region AA and on the thin-film transistor substrate 10, and at least one touch sensing electrode 120 is formed in the touch region BB and on the thin-film transistor substrate 10. In some embodiments, firstly, a plurality of anodes 1100 and the touch sensing electrode 120 are formed in the light-emitting region AA and the touch region BB respectively and on the thin-film transistor substrate 10. Then, the touch region BB is covered by a mask (not shown), and an organic light-emitting layer 1101 and a cathode 1102 are formed in sequence on each of the plurality of anodes 1100 by an evaporation process. In the present embodiment, the light-emitting device layer 11 includes a plurality of sub-pixel units 110, and each of the plurality of sub-pixel units 110 includes the anode 1100, the organic light-emitting layer 1101, and the cathode 1102 which sequentially overlap with each other.

Furthermore, as shown in FIG. 1C, an encapsulation layer 13 is formed to cover the light-emitting device layer 11 and the touch sensing electrode 120, so that a display screen 1 is prepared.

Lastly, as shown in FIG. 1D, a source-electrode driving chip 2 is electrically connected with the light-emitting device layer 11 by a bonding process, and a touch chip 3 is electrically connected with the touch sensing electrode 120 by the bonding process.

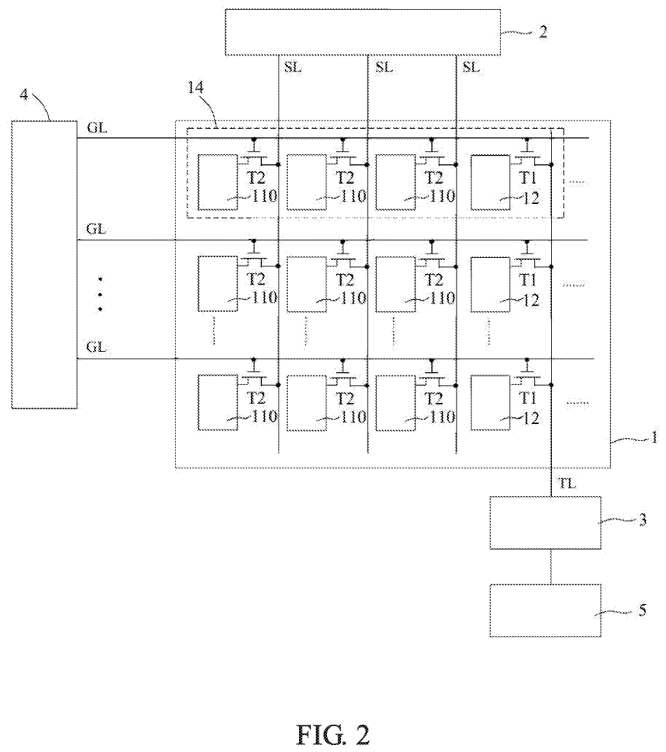

Please refer to FIG. 2, which is a schematic diagram of a circuit structure of the touch display device as shown in FIG. 1D. In the present embodiment, the touch display device includes a display screen 1, a source-electrode driving chip 2, a touch chip 3, and a gate-electrode driving chip 4. The display screen 1 includes a plurality of pixel units 14 arranged in an array, each of the plurality of pixel units 14 including a gate line GL and a touch signal line TL which intersect with each other, a touch sensing unit 12, a touch transistor T1, a plurality of data lines SL intersecting with the gate line GL, a plurality of sub-pixel units 110, and a plurality of pixel transistors T2. In the present embodiment, the touch sensing unit 12 includes a touch sensing electrode 120. A gate electrode of the touch transistor T1 is electrically connected to the gate line GL, and a drain electrode of the touch transistor T1 is electrically connected to the touch sensing unit 12. Specifically, the drain electrode of the touch transistor T1 is electrically connected to the touch sensing electrode 120 (as shown in FIG. 1D). The touch chip 3 is electrically connected to a source electrode of the touch transistor T1 through the touch signal line TL. Drain electrodes of the plurality of pixel transistors T2 are electrically connected to the plurality of sub-pixel units 110 respectively. The source-electrode driving chip 2 is electrically connected to source electrodes of the plurality of pixel transistors T2 through the data lines SL and is configured to drive the display screen 1 to display pictures. The gate-electrode driving chip 4 is electrically connected to gate electrodes of the plurality of pixel transistors T2 and to the gate electrode of the touch transistor T1 through the gate line GL. The gate-electrode driving chip 4 is configured to turn on the plurality of pixel transistors T2 and the touch transistor T1 line by line.

Continuing to refer to FIG. 2, the touch chip 3 is configured to, for each pixel unit 14: charge the touch sensing unit 12 while the display screen 1 displays the n-th frame of picture, and discharge the touch sensing unit 12 while the display screen 1 displays the (n+1)-th frame of picture, wherein n is a natural number; and compare charge data of the touch sensing unit 12 to determine a coordinate of a touch position and to generate a corresponding fingerprint signal. For example, the touch chip 3 charges the touch sensing unit 12 line by line while the display screen 1 displays the first frame of picture, and then the touch chip 3 discharges the touch sensing unit 12 line by line while the display screen 1 displays the second frame of picture. The touch chip 3 charges the touch sensing unit 12 line by line while the display screen 1 displays the third frame of picture, and then the touch chip 3 discharges the touch sensing unit 12 line by line while the display screen 1 displays the fourth frame of picture, and so on. Thus, the charging time of the touch sensing unit 12 does not occupy the gate scanning time of each frame of picture, which can significantly reduce signal noise of a touch panel and thus improve touch accuracy.

As shown in FIG. 2, the touch display device further includes a fingerprint recognizing module 5. The fingerprint recognizing module 5 is electrically connected to the touch chip 3 and is configured to recognize a fingerprint signal according to preset fingerprint data. Since a fingerprint is uneven, a capacitance between a finger and the touch sensing electrode 120 in each pixel unit 14 is different when the finger touches the display screen 1. At this time, the touch chip 3 compares the charge data of each touch sensing unit 12 to determine a coordinate of a touch position and to generate a corresponding fingerprint signal. Then, the fingerprint recognizing module 5 recognizes a fingerprint according to a capacitance distribution generated from each touch sensing unit 12.

In conclusion, a gate scanning signal is used as a scanning signal for the touch sensing unit in the touch display device of the present disclosure. In addition, the touch sensing unit is charged during a period of a frame of picture, and the touch sensing unit is discharged during a period of the next frame of picture, so that signal noise of a touch panel can be reduced, and users' identities can be monitored in real time. Thus, safety and convenience of use are improved.

It should be understood that the application of the present disclosure is not limited by the foregoing examples. A person of ordinary skill in the art is able to make modifications or changes based on the foregoing description, and all of these modifications and changes are within the scope of the appended claims of the present disclosure.

The industrial applicability of the present disclosure is that, signal noise of a touch panel can be reduced, and users' identities can be monitored in real time, thereby improving safety and convenience of use.

What is claimed is:

1. A touch display device, comprising:
a display screen comprising a plurality of pixel units arranged in an array, each of the plurality of pixel units comprising:
a gate line and a touch signal line which intersect with each other;
a touch sensing unit comprising a touch sensing electrode; and
a touch transistor, wherein a gate electrode of the touch transistor is electrically connected to the gate line, and a drain electrode of the touch transistor is electrically connected to the touch sensing unit; and
a touch chip electrically connected to a source electrode of the touch transistor through the touch signal line and configured to, for the each of the plurality of pixel units:
charge the touch sensing unit while the display screen displays the n-th frame of picture, and discharge the touch sensing unit while the display screen displays the (n+1)-th frame of picture, wherein n is a natural number; and
compare charge data of the touch sensing unit to determine a coordinate of a touch position and to generate a corresponding fingerprint signal.

2. The touch display device of claim 1, further comprising a fingerprint recognizing module electrically connected to the touch chip and configured to recognize a fingerprint signal according to preset fingerprint data.

3. The touch display device of claim 1, wherein the drain electrode of the touch transistor is electrically connected to the touch sensing electrode.

4. The touch display device of claim 1, wherein the each of the plurality of pixel units further comprises:
a plurality of data lines intersecting with the gate line;
a plurality of sub-pixel units, wherein each of the plurality of sub-pixel units comprises an anode, an organic light-emitting layer, and a cathode which sequentially overlap with each other; and
a plurality of pixel transistors, wherein drain electrodes of the plurality of pixel transistors are electrically connected to the plurality of sub-pixel units respectively.

5. The touch display device of claim 4, further comprising:
a source-electrode driving chip electrically connected to source electrodes of the plurality of pixel transistors through the plurality of data lines and configured to drive the display screen to display pictures; and
a gate-electrode driving chip electrically connected to gate electrodes of the plurality of pixel transistors and to the gate electrode of the touch transistor through the gate line, and configured to turn on the plurality of pixel transistors and the touch transistor line by line.

6. The touch display device of claim 5, wherein the touch chip charges the touch sensing unit line by line while the display screen displays the n-th frame of picture, and the touch chip discharges the touch sensing unit line by line while the display screen displays the (n+1)-th frame of picture.

7. A method of manufacturing a touch display device, comprising:
providing a thin-film transistor substrate, and defining a light-emitting region and a touch region on the thin-film transistor substrate;
forming a light-emitting device layer in the light-emitting region and on the thin-film transistor substrate, and forming at least one touch sensing electrode in the touch region and on the thin-film transistor substrate;
forming an encapsulation layer covering the light-emitting device layer and the at least one touch sensing electrode; and
electrically connecting a source-electrode driving chip with the light-emitting device layer by a bonding process, and electrically connecting a touch chip with the at least one touch sensing electrode by the bonding process.

8. The method of manufacturing a touch display device of claim 7, wherein the providing the thin-film transistor substrate comprises forming a thin-film transistor layer on an underlay substrate, and wherein the underlay substrate is one of a silicon substrate and a glass substrate.

9. The method of manufacturing a touch display device of claim 7, wherein the forming the light-emitting device layer in the light-emitting region and on the thin-film transistor substrate comprises:
forming a plurality of anodes in the light-emitting region and on the thin-film transistor substrate; and
by using a mask to cover the touch region, and forming an organic light-emitting layer and a cathode in sequence on each of the plurality of anodes.

10. The method of manufacturing a touch display device of claim 7, wherein the light-emitting device layer comprises a plurality of sub-pixel units, and wherein each of the plurality of sub-pixel units comprises an anode, an organic light-emitting layer, and a cathode which sequentially overlap with each other.

11. A touch display device, comprising:
a display screen comprising a plurality of pixel units arranged in an array, each of the plurality of pixel units comprising:
a gate line and a touch signal line which intersect with each other;
a touch sensing unit comprising a touch sensing electrode; and
a touch transistor, wherein a gate electrode of the touch transistor is electrically connected to the gate line, and a drain electrode of the touch transistor is electrically connected to the touch sensing unit; and
a touch chip electrically connected to a source electrode of the touch transistor through the touch signal line and configured to, for the each of the plurality of pixel units:
charge the touch sensing unit while the display screen displays the n-th frame of picture line by line, and discharge the touch sensing unit while the display screen displays the (n+1)-th frame of picture line by line, wherein n is a natural number; and
compare charge data of the touch sensing unit to determine a coordinate of a touch position and to generate a corresponding fingerprint signal.

12. The touch display device of claim 11, further comprising a fingerprint recognizing module electrically connected to the touch chip and configured to recognize a fingerprint signal according to preset fingerprint data.

13. The touch display device of claim 11, wherein the each of the plurality of pixel units further comprises:
a plurality of data lines intersecting with the gate line;
a plurality of sub-pixel units, wherein each of the plurality of sub-pixel units comprises an anode, an organic light-emitting layer, and a cathode which sequentially overlap with each other; and
a plurality of pixel transistors, wherein drain electrodes of the plurality of pixel transistors are electrically connected to the plurality of sub-pixel units respectively.

14. The touch display device of claim 13, further comprising:
a source-electrode driving chip electrically connected to source electrodes of the plurality of pixel transistors through the plurality of data lines and configured to drive the display screen to display pictures; and
a gate-electrode driving chip electrically connected to gate electrodes of the plurality of pixel transistors and to the gate electrode of the touch transistor through the gate line, and configured to turn on the plurality of pixel transistors and the touch transistor line by line.
